(19) United States
(12) Patent Application Publication
(10) Pub. No.: US 2008/0181144 A1
(43) Pub. Date: Jul. 31, 2008

(54) RF transceiver system with impedance mismatch detection and control and methods for use therewith

(75) Inventor: Ahmadreza (Reza) Rofougaran, Newport Coast, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/700,582

(22) Filed: Jan. 30, 2007

(51) Int. Cl. H04J 15/00; H01Q 11/12

(52) U.S. Cl. 370/297; 455/126

(57) ABSTRACT

An RF transceiver system includes an RF transmitter that generates a transmit signal and an RF receiver that receives a received signal. A diplexer couples the transmit signal to an antenna, produces the received signal based on an inbound RF signal to the antenna, and isolates the transmit signal from the received signal. A mismatch detection module detects an impedance mismatch at the output of the RF transmitter by processing the transmit signal and the received signal and generates a mismatch feedback signal in response to an amount of detected mismatch. A processing module controls the amount of mismatch at the output of the RF transmitter in response to the mismatch feedback signal.

### CROSS-REFERENCE TO RELATED APPLICATIONS

None

### BACKGROUND OF THE INVENTION

1. Technical Field of the Invention

This invention relates generally to wireless communications systems and more particularly to radio transceivers used within such wireless communication systems.

2. Description of Related Art

Communication systems are known to support wireless and wire line communications between wireless and/or wire line communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), radio frequency identification (RFID), and/or variations thereof.

Depending on the type of wireless communication system, a wireless communication device, such as a cellular telephone, two-way radio, personal digital assistant (PDA), personal computer (PC), laptop computer, home entertainment equipment, RFID reader, RFID tag, et cetera communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system or a particular RF frequency for some systems) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

For each wireless communication device to participate in wireless communications, it includes a built-in radio transceiver (i.e., receiver and transmitter) or is coupled to an associated radio transceiver (e.g., a station for in-home and/or in-building wireless communication networks, RF, modem, etc.). As is known, the transmitter includes a data modulation stage, one or more intermediate frequency stages, and a power amplifier. The data modulation stage converts raw data into baseband signals in accordance with a particular wireless communication standard. The one or more intermediate frequency stages mix the baseband signals with one or more local oscillations to produce RF signals. The power amplifier amplifies the RF signals prior to transmission via an antenna.

As is also known, the receiver is coupled to the antenna through an antenna interface and includes a low noise amplifier, one or more intermediate frequency stages, a filtering stage, and a data recovery stage. The low noise amplifier (LNA) receives inbound RF signals via the antenna and amplifies then. The one or more intermediate frequency stages mix the amplified RF signals with one or more local oscillations to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

Many wireless communication systems include receivers and transmitters that can operate over a range of possible carrier frequencies. The antenna interface provides impedance matching to the antenna over this range of frequencies in order to maximize the transfer of the received signal to the receiver. This can be challenging if the range of possible carrier frequencies is wide and/or the impedance of he antenna varies significantly over this range of frequencies. Further limitations and disadvantages of conventional and traditional approaches will become apparent to one of ordinary skill in the art through comparison of such systems with the present invention.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE SEVERAL VIEWS OF THE DRAWING(S)

FIG. 1 is a schematic block diagram of a wireless communication system in accordance with the present invention.

FIG. 2 is a schematic block diagram of a wireless communication system in accordance with the present invention.

FIG. 3 is a schematic block diagram of a wireless communication device 10 in accordance with the present invention.

FIG. 4 is a schematic block diagram of a wireless communication device 30 in accordance with the present invention.

FIG. 5 is a schematic block diagram of an RF transceiver 125 in accordance with the present invention.

FIG. 6 is a schematic block diagram of an RF transceiver 125 in accordance with a further embodiment of the present invention.

FIG. 7 is a schematic block diagram of an embodiment of mismatch detection module 141 in accordance with the present invention.

FIG. 8 is a schematic block diagram of an embodiment of antenna interface 171 in accordance with the present invention.

FIG. 9 is a schematic block diagram of a further embodiment of antenna interfaces 171 and 173 in accordance with the present invention.

FIG. 10 is a schematic block diagram of an embodiment of a radio transmitter front-end 150 in accordance with the present invention.

FIG. 11 is a schematic block diagram of an embodiment of a programmable impedance matching network 240 in accordance with the present invention.

FIG. 12 is a schematic block diagram of an embodiment of a programmable impedance matching network 242 in accordance with the present invention.

FIG. 13 is a schematic block diagram of an embodiment of a programmable impedance matching network 244 in accordance with the present invention.

FIG. 14 is a schematic block diagram of an embodiment of an adjustable impedance 290 in accordance with the present invention.

FIG. 15 is a schematic block diagram of a further embodiment of an adjustable impedance 290 in accordance with the present invention.

FIG. 16 is a schematic block diagram of a further embodiment of an adjustable impedance 290 in accordance with the present invention.

FIG. 17 is a schematic block diagram of a further embodiment of an adjustable impedance 290 in accordance with the present invention.

FIG. 18 is a schematic block diagram of a further embodiment of an adjustable impedance 290 in accordance with the present invention.

FIG. 19 is a flowchart representation of a method in accordance with an embodiment of the present invention.

### DETAILED DESCRIPTION OF THE INVENTION

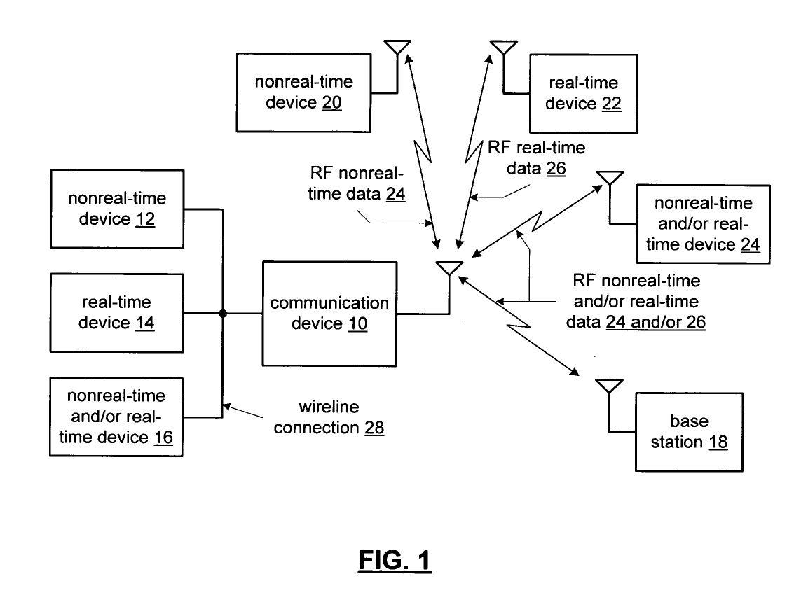

FIG. 1 is a schematic block diagram of an embodiment of a communication system in accordance with the present invention. In particular a communication system is shown that includes a communication device 10 that communicates real-time data 24 and/or non-real-time data 26 wirelessly with one or more other devices such as base station 18, non-real-time device 20, real-time device 22, and non-real-time and/or real-time device 24. In addition, communication device 10 can also optionally communicate over a wireline connection with non-real-time device 12, real-time device 14 and non-real-time and/or real-time device 16.

In an embodiment of the present invention the wireline connection 28 can be a wired connection that operates in accordance with one or more standard protocols, such as a universal serial bus (USB), Institute of Electrical and Electronics Engineers (IEEE) 488, IEEE 1394 (Firewire), Ethernet, small computer system interface (SCSI), serial or parallel advanced technology attachment (SATA or PATA), or other wired communication protocol, either standard or proprietary. The wireless connection can communicate in accordance with a wireless network protocol such as IEEE 802.11, Bluetooth, Ultra-Wideband (UWB), WIMAX, or other wireless network protocol, a wireless telephony data/voice protocol such as Global System for Mobile Communications (GSM), General Packet Radio Service (GPRS), Enhanced Data Rates for Global Evolution (EDGE), Personal Communication Services (PCS), or other mobile wireless protocol or other wireless communication protocol, either standard or proprietary. Further, the wireless communication path can include separate transmit and receive paths that use separate carrier frequencies and/or separate frequency channels. Alternatively, a single frequency or frequency channel can be used to bi-directionally communicate data to and from the communication device 10.

Communication device 10 can be a mobile phone such as a cellular telephone, a personal digital assistant, game console, personal computer, laptop computer, or other device that performs one or more functions that include communication of voice and/or data via wireline connection 28 and/or the wireless communication path. In an embodiment of the present invention, the real-time and non-real-time devices 12, 14 16, 18, 20, 22 and 24 can be personal computers, laptops, PDAs, mobile phones, such as cellular telephones, devices equipped with wireless local area network or Bluetooth transceivers, FM tuners, TV tuners, digital cameras, digital camcorders, or other devices that either produce, process or use audio, video signals or other data or communications.

In operation, the communication device includes one or more applications that include voice communications such as standard telephony applications, voice-over-Internet Protocol (VoIP) applications, local gaming, Internet gaming, email, instant messaging, multimedia messaging, web browsing, audio/video recording, audio/video playback, audio/video downloading, playing of streaming audio/video, office applications such as databases, spreadsheets, word processing, presentation creation and processing and other voice and data applications. In conjunction with these applications, the real-time data 26 includes voice, audio, video and multimedia applications including Internet gaming, etc. The non-real-time data 24 includes text messaging, email, web browsing, file uploading and downloading, etc.

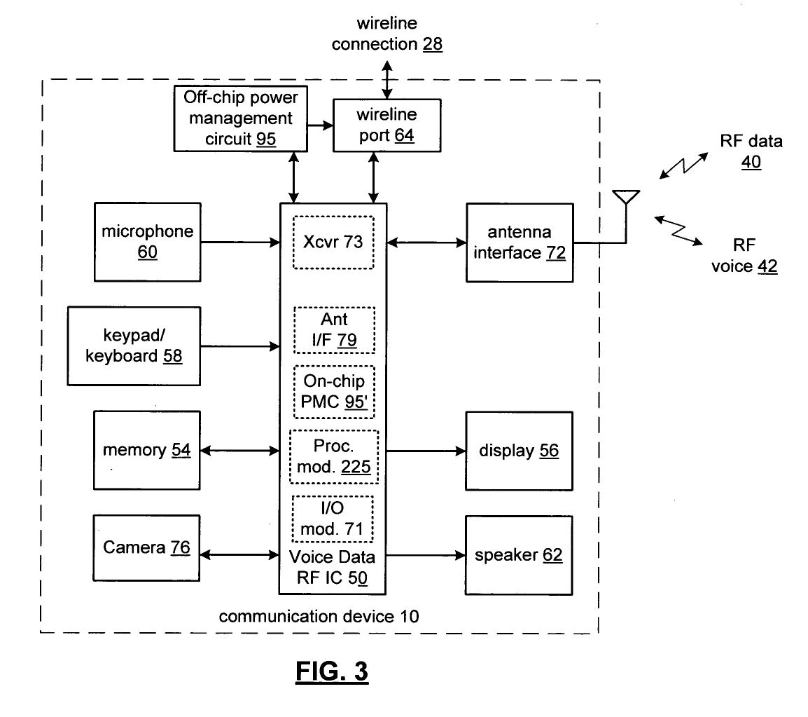

In an embodiment of the present invention, the communication device 10 includes an integrated circuit, such as a combined voice, data and RF integrated circuit that includes one or more features or functions of the present invention. Such integrated circuits shall be described in greater detail in association with FIGS. 3-19 that follow.

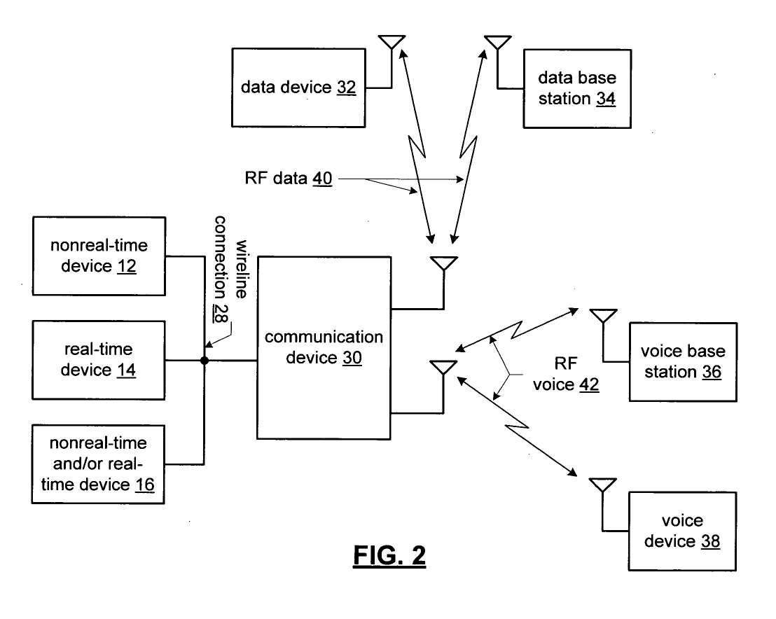

FIG. 2 is a schematic block diagram of an embodiment of another communication system in accordance with the present invention. In particular, FIG. 2 presents a communication system that includes many common elements of FIG. 1 that are referred to by common reference numerals. Communication device 30 is similar to communication device 10 and is capable of any of the applications, functions and features attributed to communication device 10, as discussed in conjunction with FIG. 1. However, communication device 30 includes two separate wireless transceivers for communicating, contemporaneously, via two or more wireless communication protocols with data device 32 and/or data base station 34 via RF data 40 and voice base station 36 and/or voice device 38 via RF voice signals 42.

FIG. 3 is a schematic block diagram of an embodiment of an integrated circuit in accordance with the present invention. In particular, a voice data RF integrated circuit (IC) 50 is shown that implements communication device 10 in conjunction with microphone 60, keypad/keyboard 58, memory 54, speaker 62, display 56, camera 76, antenna interface 52 and wireline port 64. In addition, voice data RF IC 50 includes a transceiver 73 with RF and baseband modules for formatting and modulating data into RF real-time data 26 and non-real-time data 24 and transmitting this data via an antenna interface 72, optional on-chip antenna interface 79 and antenna. Further, voice data RF IC 50 includes an input/output module 71 with appropriate encoders and decoders for communicating via the wireline connection 28 via wireline port 64, an optional memory interface for communicating with off-chip memory 54, a codec for encoding voice signals from microphone 60 into digital voice signals, a keypad/keyboard interface for generating data from keypad/keyboard 58 in response to the actions of a user, a display driver for driving display 56, such as by rendering a color video signal, text, graphics, or other display data, and an audio driver such as an audio amplifier for driving speaker 62 and one or more other interfaces, such as for interfacing with the camera 76 or the other peripheral devices.

Off-chip power management circuit 95 includes one or more DC-DC converters, voltage regulators, current regulators or other power supplies for supplying the voice data RF IC 50 and optionally the other components of communication device 10 and/or its peripheral devices with supply voltages and or currents (collectively power supply signals) that may be required to power these devices. Off-chip power management circuit 95 can operate from one or more batteries, line power and/or from other power sources, not shown. In particular, off-chip power management module can selectively supply power supply signals of different voltages, currents or current limits or with adjustable voltages, currents or current limits in response to power mode signals received from the voice data RF IC 50. Voice Data RF IC 50 optionally includes an on-chip power management circuit 95′ for replacing the off-chip power management circuit 95.

In an embodiment of the present invention, the voice data RF IC 50 is a system on a chip integrated circuit that includes at least one processing device. Such a processing device, for instance, processing module 225, may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices that are either on-chip or off-chip such as memory 54. Such a memory device may be a read-only memory, random access memory, volatile memory, non-volatile memory, static memory, dynamic memory, flash memory, and/or any device that stores digital information. Note that when the Voice Data RF IC 50 implements one or more of its functions via a state machine, analog circuitry, digital circuitry, and/or logic circuitry, the associated memory storing the corresponding operational instructions for this circuitry is embedded with the circuitry comprising the state machine, analog circuitry, digital circuitry, and/or logic circuitry.

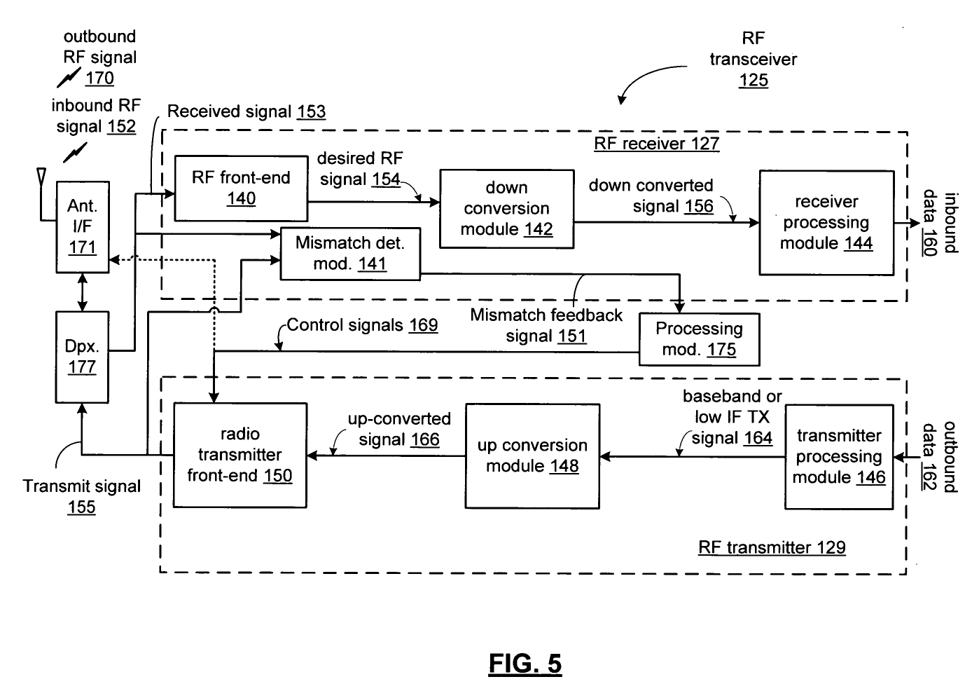

In operation, the voice data RF IC 50 executes operational instructions that implement one or more of the applications (real-time or non-real-time) attributed to communication devices 10 and 30 as discussed in conjunction with FIGS. 1 and 2. Further, RF IC 50 operates to detect impedance mismatches at the output of transceiver 73 and to control one or more components to correct or improve upon these mismatch conditions in accordance with the present invention, as will be discussed in greater detail in association with the description that follows, and particularly in conjunction with FIGS. 5-10.

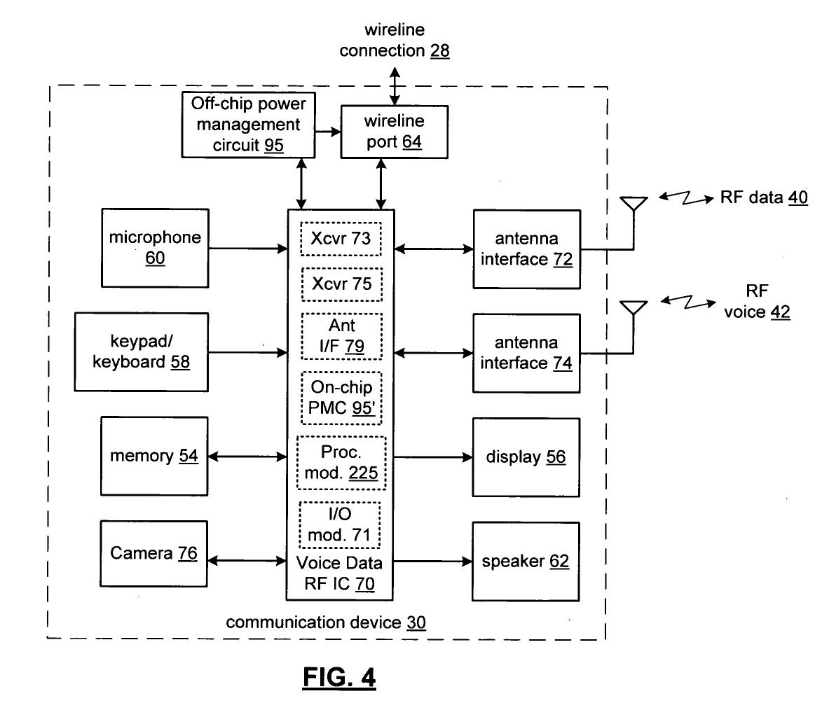

FIG. 4 is a schematic block diagram of another embodiment of an integrated circuit in accordance with the present invention. In particular, FIG. 4 presents a communication device 30 that includes many common elements of FIG. 3 that are referred to by common reference numerals. Voice data RF IC 70 is similar to voice data RF IC 50 and is capable of any of the applications, functions and features attributed to voice data RF IC 50 as discussed in conjunction with FIG. 3. However, voice data RF IC 70 includes two separate wireless 73 and 75 for communicating, contemporaneously, via two or more wireless communication protocols via RF data 40 and RF voice signals 42.

In operation, the voice data RF IC 70 executes operational instructions that implement one or more of the applications (real-time or non-real-time) attributed to communication device 10 as discussed in conjunction with FIG. 1. Further, RF IC 70 operates to detect impedance mismatches at the output of transceivers 73 and/or 75 to control one or more components to correct or improve upon these mismatch conditions in accordance with the present invention, as will be discussed in greater detail in association with the description that follows, and particularly in conjunction with FIGS. 5-10.

FIG. 5 is a schematic block diagram of an RF transceiver 125, such as transceiver 73 or 75, which may be incorporated in communication devices 10 and/or 30. The RF transceiver 125 includes an RF transmitter 129, an RF receiver 127 and a processing module 175. The RF receiver 127 includes a RF front end 140, a down conversion module 142, mismatch detection module 141 and a receiver processing module 144. The RF transmitter 129 includes a transmitter processing module 146, an up conversion module 148, and a radio transmitter front-end 150.

As shown, the receiver and transmitter are each coupled to an antenna through an off-chip antenna interface 171 and a diplexer (duplexer) 177, that couples the transmit signal 155 to the antenna to produce outbound RF signal 170 and couples inbound signal 152 to produce received signal 153. While a single antenna is represented, the receiver and transmitter may share a multiple antenna structure that includes two or more antennas. In another embodiment, the receiver and transmitter may share a multiple input multiple output (MIMO) antenna structure that includes a plurality of antennas. Each of these antennas may be fixed, programmable, and antenna array or other antenna configuration. Accordingly, the antenna structure of the wireless transceiver will depend on the particular standard(s) to which the wireless transceiver is compliant and the applications thereof.

In operation, the transmitter receives outbound data 162 from a host device or other source via the transmitter processing module 146. The transmitter processing module 146 processes the outbound data 162 in accordance with a particular wireless communication standard (e.g., IEEE 802.11, Bluetooth, RFID, GSM, CDMA, et cetera) to produce baseband or low intermediate frequency (IF) transmit (TX) signals 164. The baseband or low IF TX signals 164 may be digital baseband signals (e.g., have a zero IF) or digital low IF signals, where the low IF typically will be in a frequency range of one hundred kilohertz to a few megahertz. Note that the processing performed by the transmitter processing module 146 includes, but is not limited to, scrambling, encoding, puncturing, mapping, modulation, and/or digital baseband to IF conversion. Further note that the transmitter processing module 146 may be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the processing module 146 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

The up conversion module 148 includes a digital-to-analog conversion (DAC) module, a filtering and/or gain module, and a mixing section. The DAC module converts the baseband or low IF TX signals 164 from the digital domain to the analog domain. The filtering and/or gain module filters and/or adjusts the gain of the analog signals prior to providing it to the mixing section. The mixing section converts the analog baseband or low IF signals into up converted signals 166 based on a transmitter local oscillation 168.

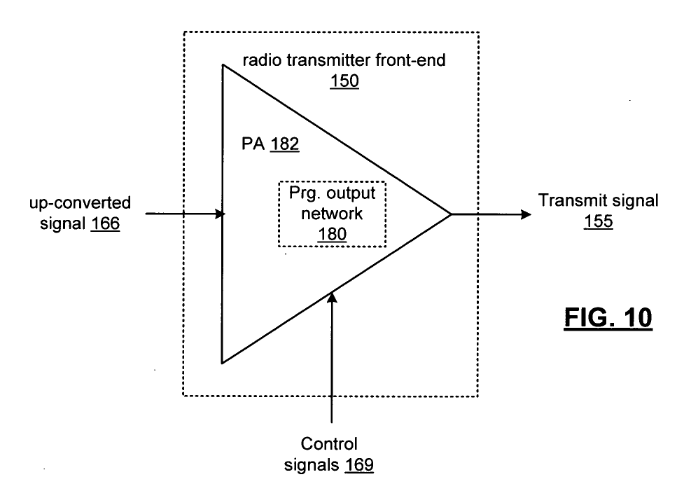

The radio transmitter front end 150 includes a power amplifier and may also include a transmit filter module. The power amplifier amplifies the up converted signals 166 to produce outbound RF signals 170, which may be filtered by the transmitter filter module, if included. The antenna structure transmits the outbound RF signals 170 to a targeted device such as a RF tag, base station, an access point and/or another wireless communication device via an antenna interface 171 coupled to an antenna that provides impedance matching and optional bandpass filtration. The radio transmitter front-end 150 can include a programmable output network that responds to control signals 169 adapt the impedance matching of the antenna interface to the particular mismatch conditions of the RF transmitter 129, as will be discussed in greater detail in conjunction with FIG. 10.

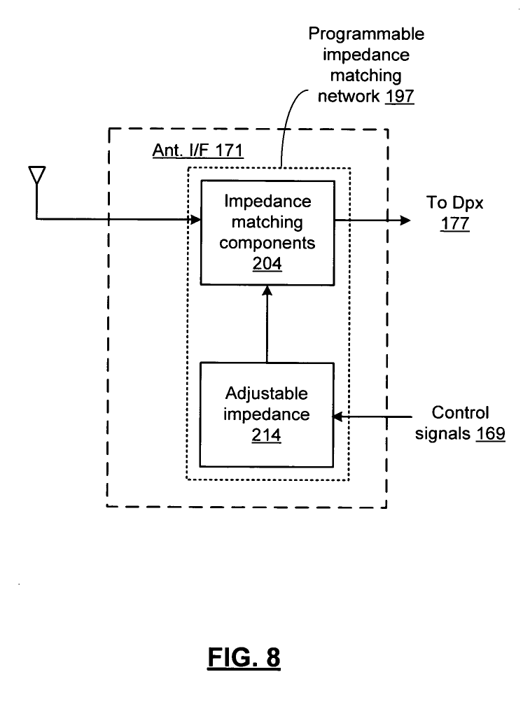

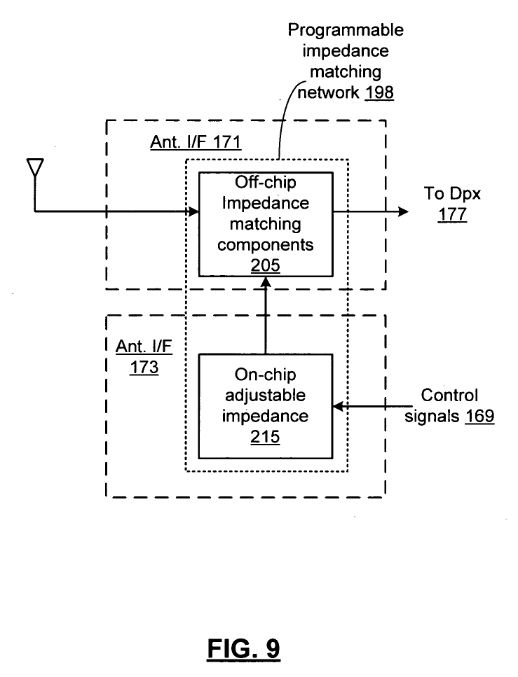

The receiver receives inbound RF signals 152 via the antenna and off-chip antenna interface 171 that operates to process the inbound RF signal 152 into received signal 153 for the receiver front-end 140. In general, antenna interface 171 provides impedance matching of antenna to the RF front-end 140 and optional bandpass filtration of the inbound RF signal 152. This interface can be either fixed or programmable based on the control signals 169 to adapt the impedance matching of the antenna interface to the particular mismatch conditions of the RF transmitter 129, as will be discussed in greater detail in conjunction with FIGS. 8-9.

The down conversion module 70 includes a mixing section, an analog to digital conversion (ADC) module, and may also include a filtering and/or gain module. The mixing section converts the desired RF signal 154 into a down converted signal 156 that is based on a receiver local oscillation 158, such as an analog baseband or low IF signal. The ADC module converts the analog baseband or low IF signal into a digital baseband or low IF signal. The filtering and/or gain module high pass and/or low pass filters the digital baseband or low IF signal to produce a baseband or low IF signal 156. Note that the ordering of the ADC module and filtering and/or gain module may be switched, such that the filtering and/or gain module is an analog module.

The receiver processing module 144 processes the baseband or low IF signal 156 in accordance with a particular wireless communication standard (e.g., IEEE 802.11, Bluetooth, RFID, GSM, CDMA, et cetera) to produce inbound data 160. The processing performed by the receiver processing module 144 includes, but is not limited to, digital intermediate frequency to baseband conversion, demodulation, demapping, depuncturing, decoding, and/or descrambling. Note that the receiver processing modules 144 may be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the receiver processing module 144 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In operation, mismatch detection module 141 detects an impedance mismatch at the output of the RF transmitter by processing the transmit signal and the received signal to determine a standing wave ratio, relative reflected signal magnitude or other indication of an impedance mismatch that could saturation the radio transmitter front-end, lower power transfer or otherwise lower the efficiency of the RF transceiver 125. In operation, mismatch detection module 141 generates a mismatch feedback signal 151 in response to an amount of detected mismatch. This mismatch feedback signal 151 signal can be an analog signal, digital signal or discrete time signal.

Processing module 175 generates a control signals 169 to control one or more components of radio transmitter front-end 150 and/or antenna interface 171 to control the amount of mismatch at the output of the RF transmitter 129 in response to the mismatch feedback signal 151. In one mode of operation, the processing module 175 is preprogrammed with the particular control signals 169 that correspond to possible mismatch feedback detection signals 151, and optionally for each carrier frequency, so that when a particular carrier frequency is in use, logic or other circuitry or programming, such as via a look-up table, can be used to retrieve the particular control signals required for that selected frequency given the current value of the mismatch feedback signal 151. In a further mode of operation, the processing module 175 iteratively tunes or utilizes feedback control techniques such as optimal control, linear quadratic regulator, proportional integral derivative (PID) control or other control techniques to control the impedance matching of the antenna interface 171 and/or radio transmitter front-end 150 to drive the mismatch feedback signal to a value or range of values that corresponds to an acceptable or substantially matched impedance condition.

In an embodiment of the present invention, processing module 175 performs various processing steps to implement the functions and features described herein. Such a processing module can be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the processing module 175 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

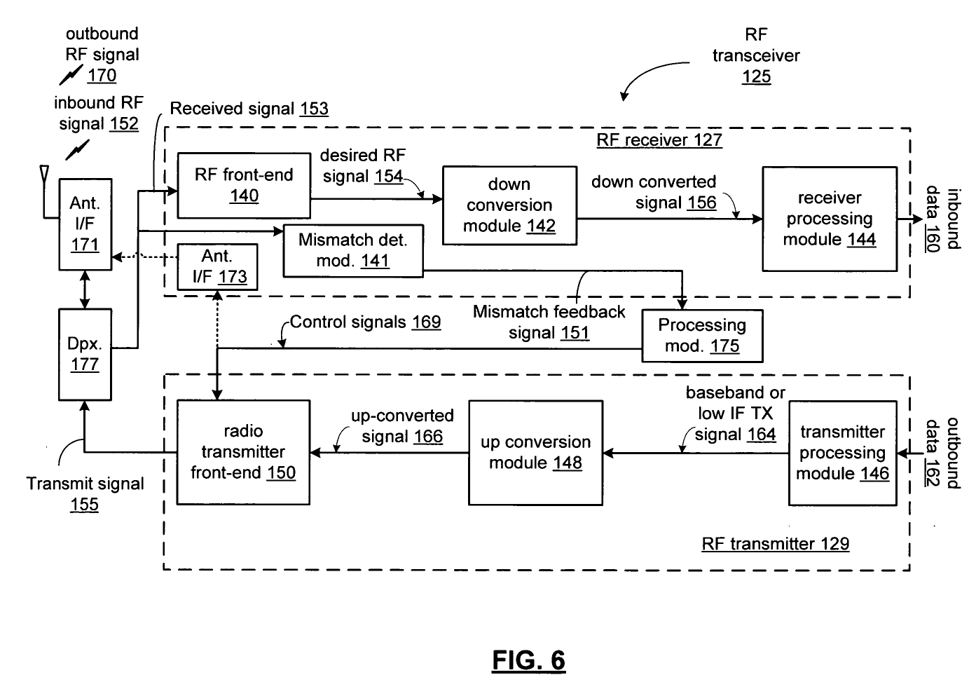

FIG. 6 is a schematic block diagram of an RF transceiver 125 in accordance with a further embodiment of the present invention. This embodiment is similar to the embodiment presented in conjunction with FIG. 5 with similar elements being referred to by common reference numerals. In this embodiment however, the RF receiver 127 receives inbound RF signals 152 via the antenna and off-chip antenna interface 171 that operates in conjunction with on-chip antenna interface 173 to process the inbound RF signal 152 into received signal 153 for the receiver front-end 140, as will be described in greater detail with reference to FIG. 9. In general, antenna interfaces 171 and 173 cooperate to provide programmable impedance matching of antenna to the RF front-end 140 and optional filtration. This interface is programmable based on the control signals 169 to adapt the impedance matching of the antenna interface 171 based on the mismatch conditions detected by mismatch detection module 141.

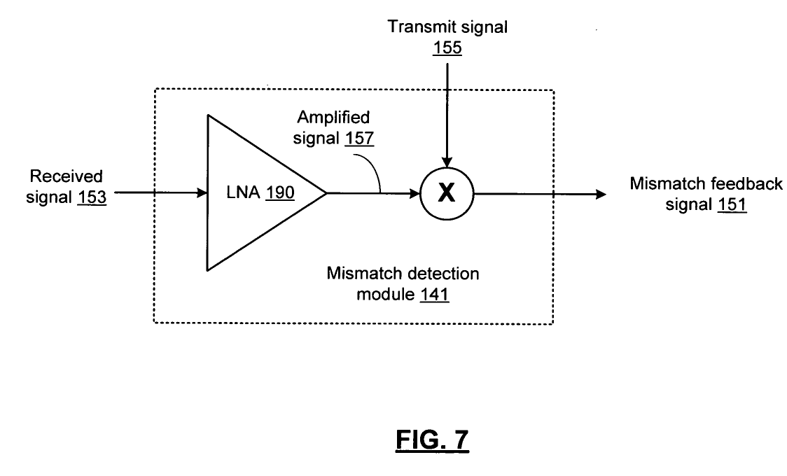

FIG. 7 is a schematic block diagram of an embodiment of mismatch detection module 141 in accordance with the present invention. In particular, mismatch detection circuit 141 includes a low noise amplifier 190 that amplifies the received signal 153 to generate an amplified signal 157. A mixer module 159 generates the mismatch feedback signal by mixing the amplified signal 157 with the transmit signal 155. During operation of the transmitter, the isolation provided by diplexer 177 produces a received signal 153 that is an attenuated version of the transmit signal 155. When this signal is amplified and mixed with the transmit signal 155, a direct current (DC) value is produced along with frequency components at twice the carrier frequency of the transmitted signal. In an embodiment of the present invention, mixer module 159 includes a filter such as a lowpass filter for filtering out these high frequency signals to pass the DC signal. In operation, the greater the impedance mismatch, the larger the magnitude of the received signal 153 and the greater the value of the DC signal that is produced. Processing module 175 operates to lower or minimize the mismatch feedback signal 151.

While the description above contemplates the use of an analog mismatch feedback signal 151, mismatch detection module 141 optionally includes an analog to digital converter for producing a digital mismatch feedback signal 151 or a sampling module for producing a discrete time mismatch feedback signal 151.

In a further embodiment of the present invention, mixer module 159 includes a antenuator for attenuating the transmit signal 155 prior to mixing, allowing the mixer module 155 to operate at lower power levels.

FIG. 8 is a schematic block diagram of an embodiment of antenna interfaces 171 in accordance with the present invention. In particular, antenna interface 171 is responsive to the control signals 169 to control the amount of mismatch at the output of the RF transmitter using a programmable impedance matching network 197. This programmable impedance matching network 197 includes fixed chip impedance matching components 204 such as one or more fixed inductors, transformers, capacitors, tank circuits or other circuit elements that combine with the on-chip adjustable impedance 214 to form impedance matching networks in a L-network, T-network, pi-network, balun, or other network configuration to provide this impedance matching. Adjustable impedance 214 has an impedance that varies based on the control signals 169 to control the amount of mismatch. In operation, the control signals 169 control the adjustable impedance 214 of programmable impedance matching network 197 to produce an overall impedance that minimizes or reduces the mismatch at the output of the RF transmitter 128 to acceptable an acceptable level.

FIG. 9 is a schematic block diagram of a further embodiment of antenna interfaces 171 and 173 in accordance with the present invention. Antenna interface 173, implemented on an integrated circuit, such as voice, data and RF IC 50 or 70 or other integrated circuit that implements RF receiver 129, includes on-chip adjustable impedance 215 that forms programmable impedance matching network 198 that operates in a similar fashion to programmable impedance matching network 197. In particular, off-chip antenna interface 171 includes one or more first off-chip impedance matching components 205 that are coupleable to the antenna. The off-chip impedance matching components 205 of programmable impedance matching networks 198 can include one or more fixed inductors, transformers, capacitors, tank circuits or other circuit elements that combine with the on-chip adjustable impedance 215 to form impedance matching networks in a L-network, T-network, pi-network, balun, or other network configuration to provide this impedance matching.

FIG. 10 is a schematic block diagram of an embodiment of a radio transmitter front-end 150 in accordance with the present invention. In particular radio transmitter front-end 150 includes a power amplifier 182 having a programmable output network 180 that is responsive to the control signals 169 to control the amount of mismatch at the output of the RF transmitter. Like the programmable impedance matching networks 197 and 198, programmable output network 180 can be implemented with one or more adjustable impedances that modify the magnitude and phase of the transmit signal 155 and/or the transmission impedance of the power amplifier 182 to improve the impedance mismatch on the output of the power amplifier 182 by controlling the value of the one or more adjustable impedances of programmable output network 180 using control signals 169.

In an embodiment of the present invention, programmable output network 180 includes optional bandpass filtration for passing only frequencies within a desired passband, attenuating undesired spurs and harmonics, etc.

FIG. 11 is a schematic block diagram of an embodiment of a programmable impedance matching network 240 in accordance with the present invention. In particular, a programmable impedance matching network 240, such as programmable impedance matching network 197 or 198 or programmable output network 180, includes two off-chip impedance matching components, represented by impedances Zᵢ and Zⱼ, and an adjustable impedance 290 that responds to control signals 221, such as control signals 169, that are connected in a T-network configuration. Each of the impedances Zᵢ and Zⱼ can be implemented with a single or multiple impedance matching components such as inductors, capacitors, resistors, transformers or other circuit components. When implemented a part of antenna interface 171, node A is coupled to either the antenna, or the diplexer 177, with node B have a connection to the remaining element. As programmable output network 180, node A can be coupled as either the output of power amplifier 182 or as the output of a power output stage, with node B have a connection to the remaining element.

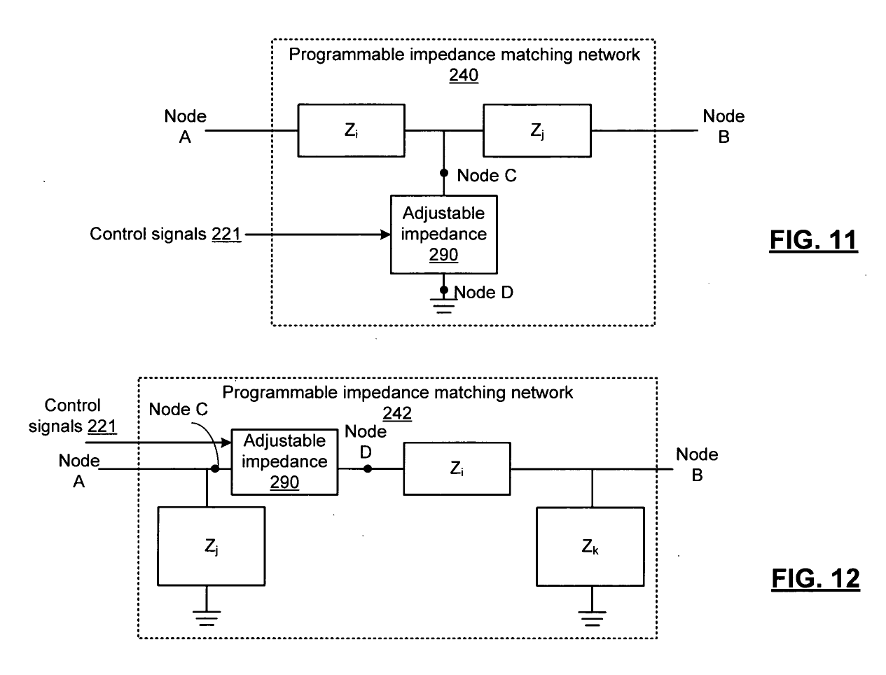

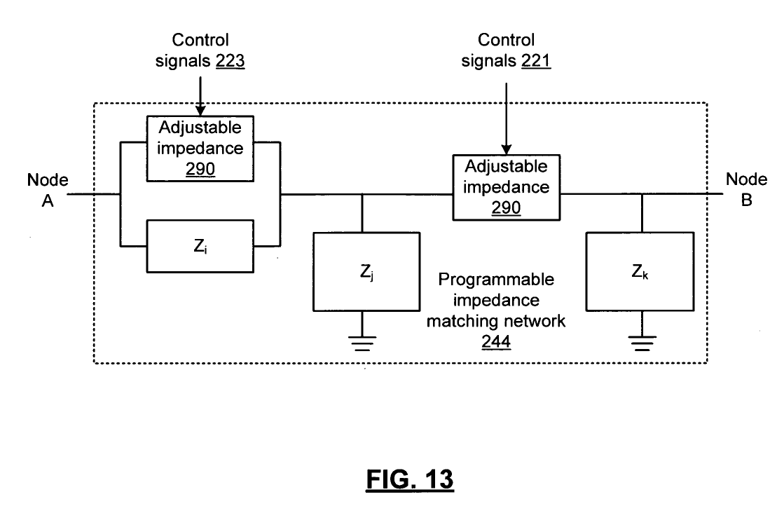

FIG. 12 is a schematic block diagram of an embodiment of a programmable impedance matching network 242 in accordance with the present invention. In particular, a programmable impedance matching network 242, such as programmable impedance matching network 197 or 198 or programmable output network 180, includes three off-chip impedance matching components, represented by impedances Zᵢ, Zⱼ and Zₖ, and an adjustable impedance 290 that responds to control signals 221, such as control signals 169, that are connected in a pi-network configuration. Each of the impedances Zᵢ, Zⱼ and Zₖ can be implemented with single or multiple impedance matching components such as inductors, capacitors, resistors, transformers or other circuit components. When implemented a part of antenna interface 171, node A is coupled to either the antenna, or the diplexer 177, with node B have a connection to the remaining element. As programmable output network 180, node A can be coupled as either the output of power amplifier 182 or as the output of a power output stage, with node B have a connection to the remaining element.

It should be noted that programmable impedance matching networks 240 and 242 demonstrate only two examples of many possible configurations within the broad scope of the present invention. It should be noted that, while each design includes only one adjustable impedance 290, likewise, multiple adjustable impedances may be implemented and be separately adjustable by additional control signals 169 from processing module 175. It should also be noted that these adjustable impedances may be implemented with one node coupled to a reference node such as ground, as shown in FIG. 11, or with both nodes coupled to the off-chip impedance matching components, as shown in FIG. 12.

FIG. 13 is a schematic block diagram of an embodiment of a programmable impedance matching network 244 in accordance with the present invention. In particular, this circuit also includes a programmable bandpass filter, for implementation as programmable impedance matching network 197 or 198 or programmable output network 180. This circuit includes three fixed components, represented by impedances Zᵢ, Zⱼ and Zₖ, and two adjustable impedances 290 that respond to control signals 221 and 223, such as control signals 169. Each of the impedances Zᵢ, Zⱼ and Zₖ can be implemented with a single or multiple impedance matching components such as inductors, capacitors, resistors, transformers or other circuit components. When implemented a part of antenna interface 171, node A is coupled to either the antenna, or the diplexer 177, with node B have a connection to the remaining element. As programmable output network 180, node A can be coupled as either the output of power amplifier 182 or as the output of a power output stage, with node B have a connection to the remaining element. It should be noted that these adjustable impedances may be implemented with one node coupled to a reference node such as ground, or with both nodes coupled to the off-chip impedance matching components, as shown in FIG. 13.

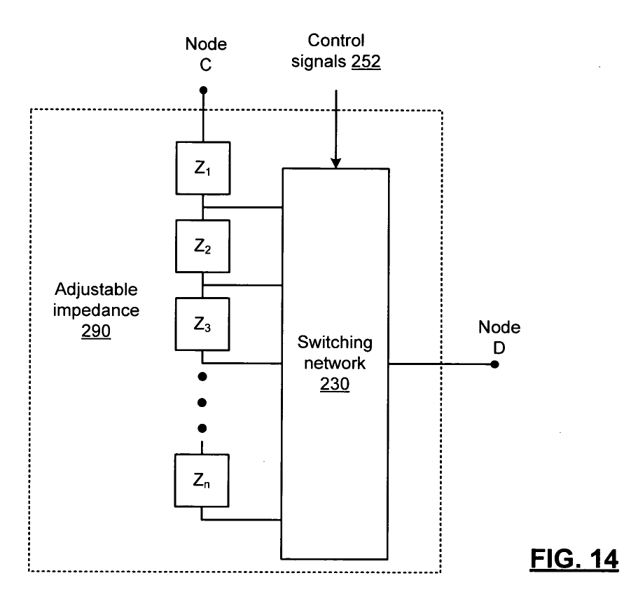

FIG. 14 is a schematic block diagram of an embodiment of an adjustable impedance in accordance with the present invention. An adjustable impedance 290 is shown that includes a plurality of fixed network elements Z₁, Z₂, Z₃, . . . Zₙ such as resistors, or reactive network elements such as capacitors, and/or inductors. A switching network 230 selectively couples the plurality of fixed network elements in response to one or more control signals 252, such as control signals 221 and/or 223. In operation, the switching network 230 selects at least one of the plurality of fixed reactive network elements and that deselects the remaining ones of the plurality of fixed reactive network elements in response to the control signals 252. In particular, switching network 230 operates to couple one of the plurality of taps to terminal B. In this fashion, the impedance between terminals A and B is adjustable to include a total impedance Z₁, Z₁+Z₂, Z₁+Z₂+Z₃, etc, based on the tap selected. Choosing the fixed network elements Z₁, Z₂, Z₃, . . . Zₙ to be a plurality of inductors, allows the adjustable impedance 220 to implement an adjustable inductor having a range from (Z₁ to Z₁+Z₂+Z₃+ . . . . +Zₙ). Similarly, choosing the fixed network elements Z₁, Z₂, Z₃, . . . Zₙ to be a plurality of capacitors, allows the adjustable impedance 220 to implement an adjustable capacitor, etc.

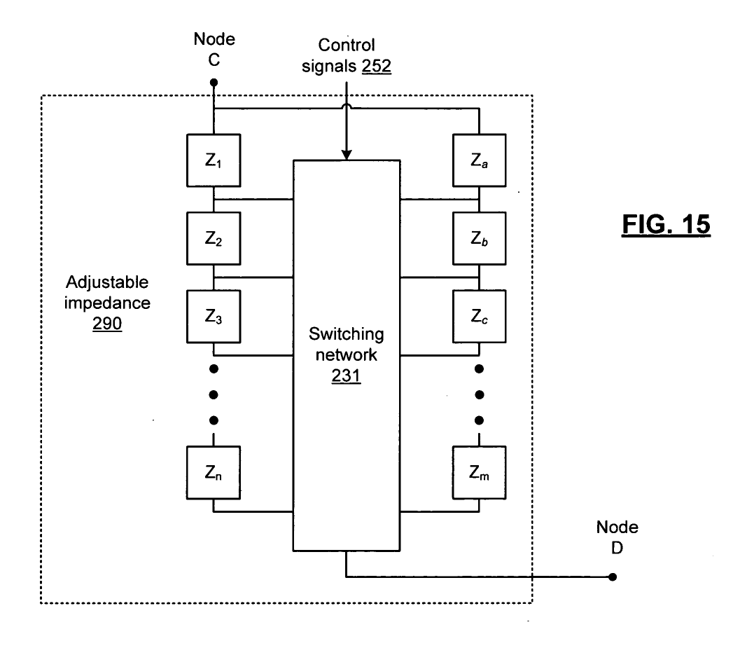

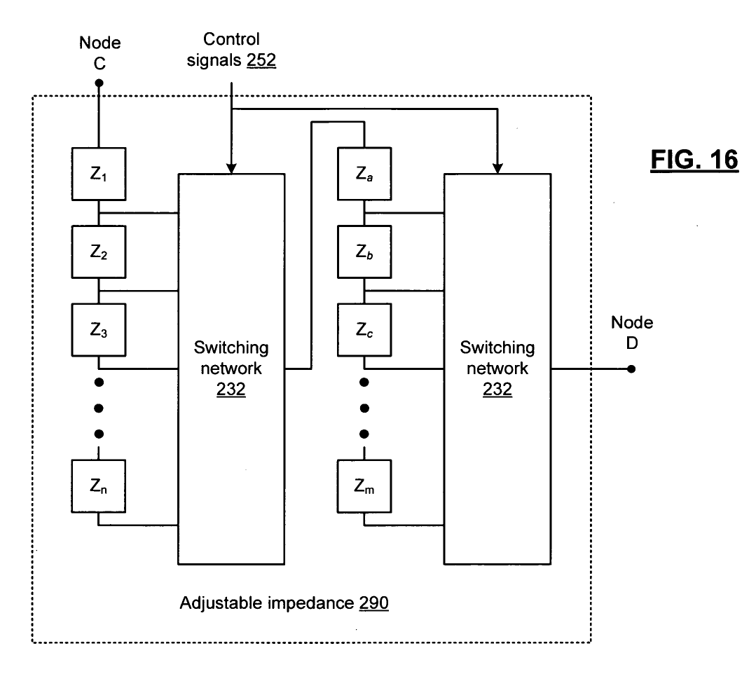

FIG. 15 is a schematic block diagram of an embodiment of an adjustable impedance in accordance with the present invention. An adjustable impedance 290 is shown that includes a plurality of group A fixed network elements Z₁, Z₂, Z₃, . . . Zₙ and group B fixed network elements Zₐ, Z_{b}, Z_{c}, . . . Zₘ such as resistors, or reactive network elements such as capacitors, and/or inductors. A switching network 231 selectively couples the plurality of fixed network elements in response to one or more control signals 252, such as control signals 221 and/or 223 to form a parallel combination of two adjustable impedances. In operation, the switching network 231 selects at least one of the plurality of fixed reactive network elements and that deselects the remaining ones of the plurality of fixed reactive network elements in response to the control signals 252. In particular, switching network 231 operates to couple one of the plurality of taps from the group A impedances to one of the plurality of taps of the group B impedances to the terminal B. In this fashion, the impedance between terminals A and B is adjustable and can be to form a parallel circuit such as parallel tank circuit having a total impedance equal to the parallel combination between a group A impedance Z_{A}=Z₁, Z₁+Z₂, or Z₁+Z₂+Z₃, etc, and a Group B impedance Z_{B}=Zₐ, Zₐ+Z_{b}, or Zₐ+Z_{b}+Z_{c}, etc., based on the taps selected.

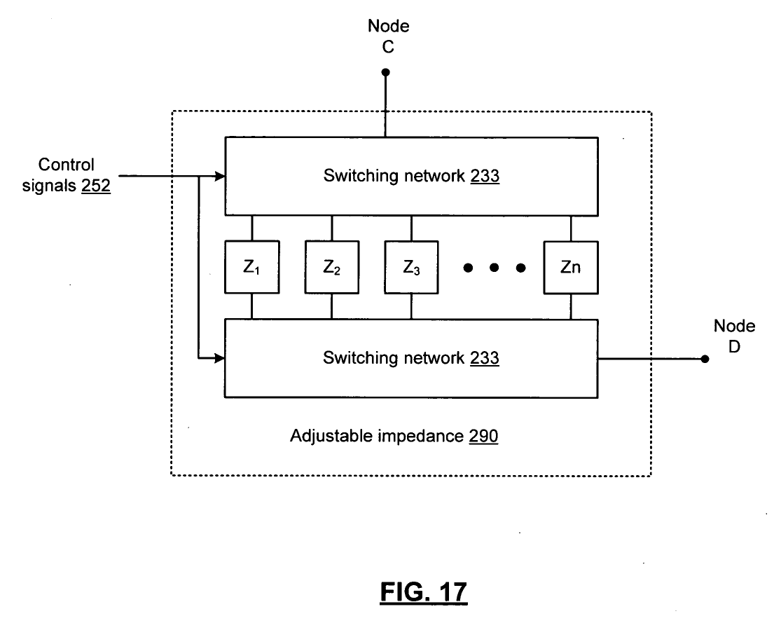

FIG. 16 is a schematic block diagram of an embodiment of an adjustable impedance in accordance with the present invention. An adjustable impedance 290 is shown that includes a plurality of group A fixed network elements Z₁, Z₂, Z₃, . . . Zₙ and group B fixed network elements Zₐ, Z_{b}, Z_{c}, . . . Zₘ such as resistors, or reactive network elements such as capacitors, and/or inductors. A switching network 232 selectively couples the plurality of fixed network elements in response to one or more control signals 252, such as control signals 221 and/or 223 to form a series combination of two adjustable impedances. In operation, the switching network 232 selects at least one of the plurality of fixed reactive network elements and that deselects the remaining ones of the plurality of fixed reactive network elements in response to the control signals 252. In particular, switching network 232 operates to couple one of the plurality of taps from the group A impedances to the group B impedances and one of the plurality of taps of the group B impedances to the terminal B. In this fashion, the impedance between terminals A and B is adjustable and can be to form a series circuit such as series tank circuit having a total impedance equal to the series combination between a group A impedance Z_{A}=Z₁, Z₁+Z₂, or Z₁+Z₂+Z₃, etc, and a Group B impedance Z_{B}=Zₐ, Zₐ+Z_{b}, or Zₐ+Z_{b}+Z_{c}, etc., based on the taps selected.

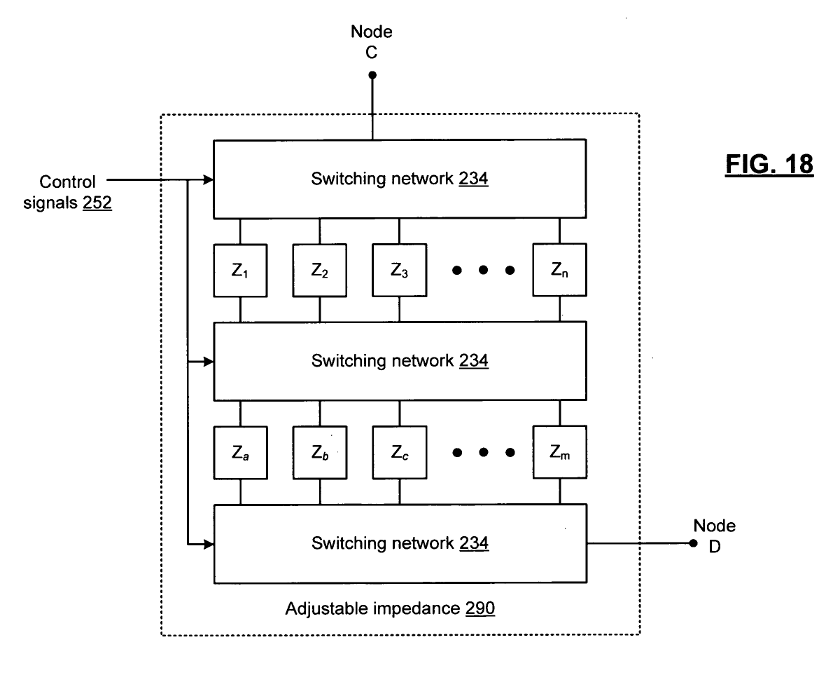

FIG. 17 is a schematic block diagram of an embodiment of an adjustable impedance in accordance with the present invention. An adjustable impedance 290 is shown that includes a plurality of fixed network elements Z₁, Z₂, Z₃, . . . Zₙ such as resistors, or reactive network elements such as capacitors, and/or inductors. A switching network 233 selectively couples the plurality of fixed network elements in response to one or more control signals 252, such as control signals 221 and/or 223. In operation, the switching network 233 selects at least one of the plurality of fixed reactive network elements and that deselects the remaining ones of the plurality of fixed reactive network elements in response to the control signals 252. In particular, switching network 233 operates to couple one of the plurality of taps of the top legs of the selected elements to terminal A and the corresponding bottom legs of the selected elements to terminal B. In this fashion, the impedance between terminals A and B is adjustable to include a total impedance that is the parallel combination of the selected fixed impedances. Choosing the fixed network elements Z₁, Z₂, Z₃, . . . Zₙ to be a plurality of inductances, allows the adjustable impedance 220 to implement an adjustable inductor, from the range from the parallel combination of (Z₁, Z₂, Z₃, . . . Zₙ) to MAX(Z₁, Z₂, Z₃ . . . . Zₙ). Also, the fixed network elements Z₁, Z₂, Z₃, . . . Zₙ can be chosen as a plurality of capacitances.

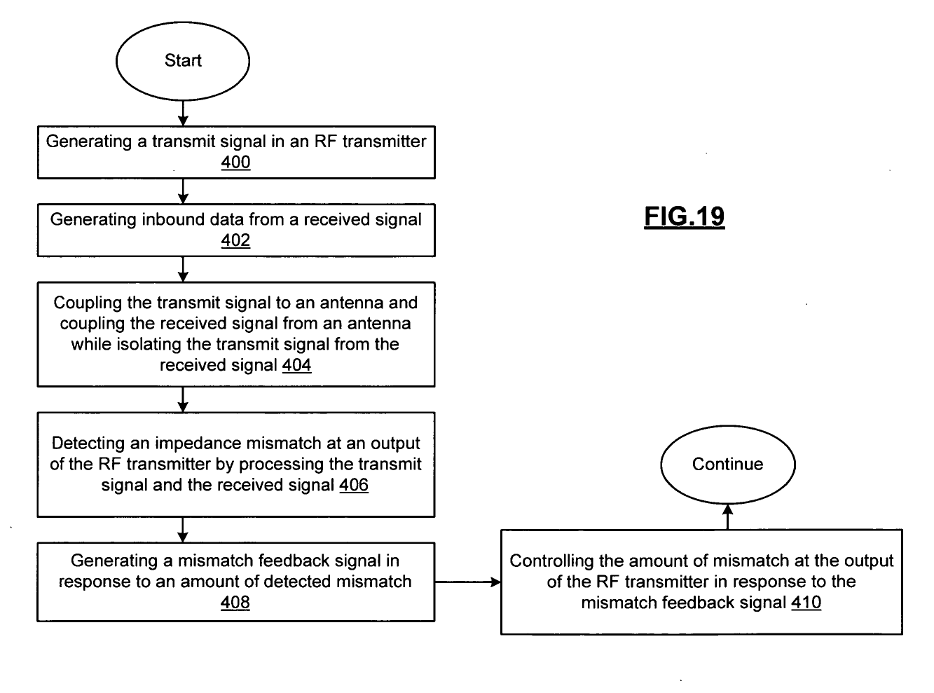

FIG. 18 is a schematic block diagram of an embodiment of an adjustable impedance in accordance with the present invention. An adjustable impedance 290 is shown that includes a plurality of group A fixed network elements Z₁, Z₂, Z₃, . . . Zₙ and group B fixed network elements Zₐ, Z_{b}, Z_{c}, . . . Zₘ such as resistors, or reactive network elements such as capacitors, and/or inductors. A switching network 234 selectively couples the plurality of fixed network elements in response to one or more control signals 252, such as control signals 221 and/or 223 to form a series combination of two adjustable impedances. In operation, the switching network 234 selects at least one of the plurality of fixed reactive network elements and that deselects the remaining ones of the plurality of fixed reactive network elements in response to the control signals 252. In particular, switching network 232 operates to couple a selected parallel combination of impedances from the group A in series with a selected parallel combination of group B impedances. In this fashion, the impedance between terminals A and B is adjustable and can be to form a series circuit such as series tank circuit having a total impedance equal to the series combination between a group A impedance Z_{A} and a Group B impedance Z_{B}, based on the taps selected.

FIG. 19 is a flowchart representation of a method in accordance with an embodiment of the present invention. In particular a method is presented for use with one or more features or functions presented in conjunction with FIGS. 1-18. In step 400, a transmit signal is generated in an RF transmitter. In step 402, inbound data is generated from a received signal. In step 404, the transmit signal is coupled to an antenna and the received signal is coupled from the antenna while isolating the transmit signal from the received signal. In step 406, an impedance mismatch is detected at an output of the RF transmitter by processing the transmit signal and the received signal. In step 408, a mismatch feedback signal is generated in response to an amount of detected mismatch. In step 410, the amount of mismatch is controlled at the output of the RF transmitter in response to the mismatch feedback signal.

In an embodiment of the present invention, step 408 includes amplifying the received signal to generate an amplified signal, and mixing the amplified signal with the transmit signal. In an embodiment, step 410 includes programming an output network of the RF transmitter and/or programming a programmable impedance matching network.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

While the transistors discussed above may be field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A (radio frequency) RF transceiver system comprising:
an RF transmitter, having an output, that generates a transmit signal from outbound data;
an RF receiver that generates inbound data from a received signal;
a diplexer, coupled to the RF transmitter and the RF receiver, that couples the transmit signal to an antenna, that produces the received signal based on an inbound RF signal to the antenna, and that isolates the transmit signal from the received signal;
a mismatch detection module, coupled to the diplexer, that detects an impedance mismatch at the output of the RF transmitter by processing the transmit signal and the received signal and that generates a mismatch feedback signal in response to an amount of detected mismatch; and
a processing module, coupled to the mismatch detection module, that generates a control signal to control the amount of mismatch at the output of the RF transmitter in response to the mismatch feedback signal.

2. The RF transceiver system of claim 1 wherein the mismatch detection module includes:
a low noise amplifier that amplifies the received signal to generate an amplified signal; and
a mixer module, coupled to the low noise amplifier, that generates the mismatch feedback signal by mixing the amplified signal with the transmit signal.

3. The RF transceiver system of claim 1 wherein the RF transmitter includes a power amplifier having a programmable output network that is responsive to the control signal to control the amount of mismatch at the output of the RF transmitter.

4. The RF transceiver system of claim 3 wherein the programmable output network includes at least one adjustable impedance.

5. The RF transceiver system of claim 4 wherein the at least one adjustable impedance includes a plurality of fixed reactive network elements and a switching network for selectively coupling the plurality of fixed reactive network elements in response to the control signal.

6. The RF transceiver system of claim 1 further comprising:
a first antenna interface, coupled to the diplexer, the antenna and the processing module that is responsive to the control signal to control the amount of mismatch at the output of the RF transmitter.

7. The RF transceiver system of claim 6 wherein the first antenna interface includes a programmable impedance matching network having at least one adjustable impedance that varies based on the control signal.

8. The RF transceiver system of claim 7 wherein the at least one adjustable impedance includes a plurality of fixed reactive network elements and a switching network for selectively coupling the plurality of fixed reactive network elements in response to the control signal.

9. The RF transceiver system of claim 6 wherein the RF transmitter and the RF receiver are implemented on an integrated circuit and wherein the first antenna interface is an off-chip circuit that includes at least one off-chip impedance matching component, the RF transceiver system further comprising:
an on-chip antenna interface, coupled to the first antenna interface, that forms a programmable impedance matching network with the at least one off-chip impedance matching component, wherein the first programmable impedance matching network is programmable based on the control signal.

10. The RF transceiver system of claim 9 wherein the on-chip antenna interface includes:
at least one adjustable impedance coupled to the at least one first off-chip impedance matching component, that has an impedance value that varies based on the control signal.

11. The RF transceiver system of claim 10 wherein the at least one adjustable impedance includes a plurality of fixed reactive network elements and a switching network for selectively coupling the plurality of fixed reactive network elements in response to the control signal.

12. A method comprising:
generating a transmit signal in an RF transmitter;
generating inbound data from a received signal;
coupling the transmit signal to an antenna and coupling the received signal from the antenna while isolating the transmit signal from the received signal;
detecting an impedance mismatch at an output of the RF transmitter by processing the transmit signal and the received signal;
generating a mismatch feedback signal in response to an amount of detected mismatch;
controlling the amount of mismatch at the output of the RF transmitter in response to the mismatch feedback signal.

13. The method of claim 12 wherein the step of mismatch feedback signal includes:
amplifying the received signal to generate an amplified signal; and
mixing the amplified signal with the transmit signal.

14. The method of claim 12 wherein the step of controlling the amount of mismatch includes programming an output network of the RF transmitter.

15. The method of claim 12 wherein the step of controlling the amount of mismatch includes programming a programmable impedance matching network.

16. A (radio frequency) RF transceiver system comprising:
an RF transmitter, having an output, that generates a transmit signal;
an RF receiver that receives a received signal;
a diplexer, coupled to the RF transmitter and the RF receiver, that couples the transmit signal to an antenna, that produces the received signal based on an inbound RF signal to the antenna, and that isolates the transmit signal from the received signal;
a mismatch detection module, coupled to the diplexer, that detects an impedance mismatch at the output of the RF transmitter by processing the transmit signal and the received signal and that generates a mismatch feedback signal in response to an amount of detected mismatch; and
a processing module, coupled to the mismatch detection module, that controls the amount of mismatch at the output of the RF transmitter in response to the mismatch feedback signal.

17. The RF transceiver system of claim 16 wherein the mismatch detection module includes:
a low noise amplifier that amplifies the received signal to generate an amplified signal; and
a mixer module, coupled to the low noise amplifier, that generates the mismatch feedback signal by mixing the amplified signal with the transmit signal.

18. The RF transceiver system of claim 16 wherein the processing module generates a control signal and wherein the RF transmitter includes a power amplifier having a programmable output network that is responsive to the control signal to control the amount of mismatch at the output of the RF transmitter.

19. The RF transceiver system of claim 18 wherein the programmable output network includes at least one adjustable impedance.

20. The RF transceiver system of claim 19 wherein the at least one adjustable impedance includes a plurality of fixed reactive network elements and a switching network for selectively coupling the plurality of fixed reactive network elements in response to the control signal.

21. The RF transceiver system of claim 18 wherein the processing module generates a control signal, and the RF transceiver further comprises:
a first antenna interface, coupled to the diplexer, the antenna and the processing module that is responsive to the control signal to control the amount of mismatch at the output of the RF transmitter.

22. The RF transceiver system of claim 21 wherein the first antenna interface includes a programmable impedance matching network having at least one adjustable impedance that varies based on the control signal.

23. The RF transceiver system of claim 22 wherein the at least one adjustable impedance includes a plurality of fixed reactive network elements and a switching network for selectively coupling the plurality of fixed reactive network elements in response to the control signal.

24. The RF transceiver system of claim 21 wherein the processing module generates a control signal, wherein the RF transmitter and the RF receiver are implemented on an integrated circuit and wherein the first antenna interface is an off-chip circuit that includes at least one off-chip impedance matching component, the RF transceiver system further comprising:
an on-chip antenna interface, coupled to the first antenna interface, that forms a programmable impedance matching network with the at least one off-chip impedance matching component, wherein the first programmable impedance matching network is programmable based on the control signal.

25. The RF transceiver system of claim 24, wherein the on-chip antenna interface includes:
at least one adjustable impedance coupled to the at least one first off-chip impedance matching component, that has an impedance value that varies based on the control signal.

26. The RF transceiver system of claim 25 wherein the at least one adjustable impedance includes a plurality of fixed reactive network elements and a switching network for selectively coupling the plurality of fixed reactive network elements in response to the control signal.
